(19) United States
(12) Patent Application Publication
(10) Pub. No.: US 2007/0283028 A1
(43) Pub. Date: Dec. 6, 2007

(54) Name Challenge Enabled Zones

(75) Inventors: James M. Gilroy, Redmond, WA (US); Jeffrey J. Westhead, Duvall, WA (US); Kamal Anupama Janardhan, Redmond, WA (US); Moon Majumdar, Seattle, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/421,641

(22) Filed: Jun. 1, 2006

(51) Int. Cl. G06F 15/16

(52) U.S. Cl. 709/230

(57) ABSTRACT

A method and system for implementing name challenge enabled zones is described herein. A DNS server receives an update from a client device. If the DNS server hosts an authoritative zone for the update, the DNS server determines whether there is a record for the host name. If so, then the IP address associated with the host name is determined. The IP address is compared to the source address of the client device sending the update. If the IP addresses match, then the update is accepted.

### BACKGROUND

The Domain Name System (DNS) is a system that stores information associated with domain names in a distributed database on one or more networks. The stored information includes the Internet Protocol (IP) address associated with a domain name. The domain name space may be thought of as a tree of domain names. Each node or leaf in the tree is associated with resource records, which hold information associated with the domain name. The tree is divided into zones. A zone is a collection of connected nodes that are authoritatively served by an authoritative DNS server. A DNS server may host one or more zones.

Zones may be stored using text-based files or by using a directory system. Zones may be configured to accept dynamic updates from client machines to handle a change in the machine name, IP address, or other domain information. Dynamic updates may be secure or unsecure. Secure updates may require a security context negotiation between a client machine and a DNS server. Using secure updates may require that only the original owner of a registered name may make changes to that existing record. Registration attempts by other client machines for the same name are rejected. Secure updates require domain credentials and are not available to zones that are stored using text-based files.

Unsecure updates allow clients to create a new registration or modify an existing registration. Unsecure updates for existing data are not restricted to the original owner. Therefore, another machine may perform a dynamic update for the same name. If this is done maliciously, it is known as a name hijacking attack. Unsecure updates do not require domain credentials and may be used regardless of what storage system is used for the zone. However, by using unsecure updates, clients are vulnerable to name hijacking attacks and cannot be guaranteed name uniqueness in a zone.

### SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

Described herein are various technologies and techniques directed to methods and systems for implementing name challenge enabled zones. In accordance with one implementation of the described technologies, when a DNS server receives an update for a name, the DNS server checks to see if the host name already exists in the applicable zone. If there is already a record for the name, then the DNS server determines whether the identities of the original registrant and the client device sending the update are the same by comparing their source IP addresses. If the source IP addresses are the same, then the update is accepted. If the source IP addresses are different, the DNS server may send a DNS query to the original registrant. If the original registrant responds to the DNS query, then the update is rejected. If the original registrant does not respond to the DNS query, then the update may be accepted.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 is a block diagram illustrating an exemplary system for implementing name challenge.

FIG. 2 is a screenshot illustrating an exemplary user interface for managing DNS zones.

FIG. 3 is a screenshot illustrating an exemplary user interface for viewing and editing properties of a DNS zone.

FIG. 4 is a flow diagram illustrating an exemplary process for implementing name challenge.

FIG. 5 illustrates an exemplary computing environment in which certain aspects of the invention may be implemented.

Like reference numerals are used to designate like parts in the accompanying drawings.

### DETAILED DESCRIPTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

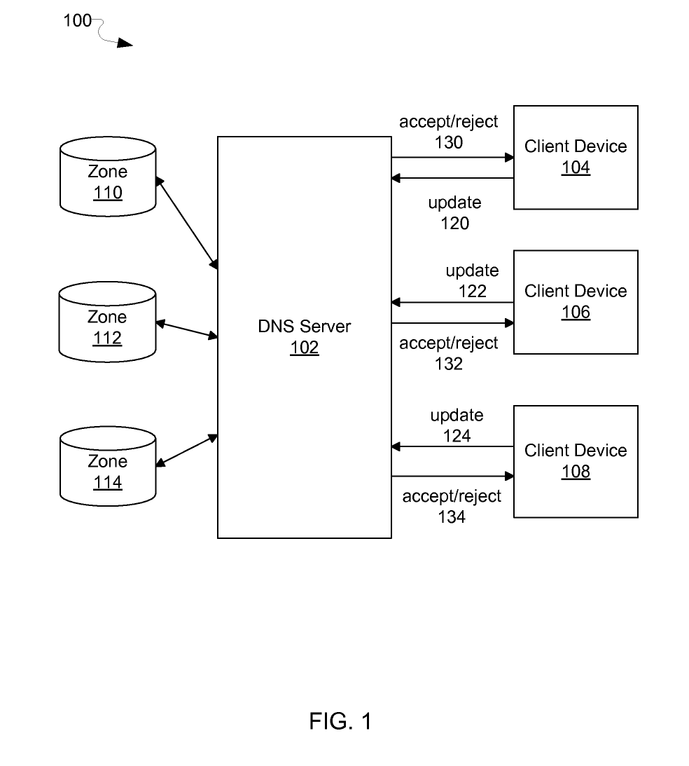

FIG. 1 is a block diagram illustrating an exemplary system 100 for implementing name challenge for one or more zones on a DNS server 102. The DNS server 102 is communicatively coupled to one or more client devices, such as 104, 106, or 108. The DNS server 102 hosts one or more zones, such as 110, 112, or 114. Each zone includes one or more records that store domain information, such as a mapping of IP addresses to the client devices in the domain. The one or more zones may be file-backed or integrated with a directory system, such as an Active Directory system. The one or more zones may be configured to accept dynamic updates from client devices to handle one or more changes in a client device name, IP address, or other domain information. Dynamic updates may be secure or unsecure. Secure updates may require a security context negotiation between a client device and the DNS server. Secure updates may require that only the original client device that registered a domain name may make changes to the record associated with that domain name. Registrations from other client devices that attempt for the same domain name would be rejected.

Unsecure updates allow clients to create a new registration or modify an existing registration. Unsecure updates for existing data are not restricted to the original owner. System 100, as shown in FIG. 1, allows for unsecure dynamic updates and implements name challenge for updates that conflict with existing registrations. Each client device, such as 104, 106, or 108, may send updates, such as 120, 122, or 124, to the DNS server 102. When the DNS server 102 receives an update, the DNS server checks to see if the host name already exists in the applicable zone. If there is already a record for the host name, then the DNS server 102 determines whether the identities of the original registrant and the client device sending the update are the same by comparing their source IP addresses. If the source IP addresses are the same, then the update is accepted. If the source IP addresses are different, the DNS server may send a DNS query to the original registrant. If the original registrant responds to the DNS query, then the update is rejected. If the original registrant does not respond to the DNS query, then the update may be accepted. The DNS server 102 sends a response, such as 130, 132, or 134, back to the client device that requested the update to notify the client device of the acceptance or rejection of the requested update.

For example, assume that zone 110 stores records for the domain “corp.contoso.com.” The zone 110 has an address (A) record for “lab-comp.corp.contoso.com” that was created by a registration received from client device 104. Client device 104 has the host name “lab-comp” that was joined to the “corp.contoso.com” domain.

In a first scenario, suppose that client device 104 sends a dynamic update for “lab-comp.corp.contoso.com” to refresh its A record. When the authoritative DNS server 102 is found, it checks for any existing data for the A record for “lab-comp” in the “corp.contoso.com” zone. The A record for “lab-comp” already exists. Therefore, the DNS server checks to see if the source address of the original registrant and the source address of the client device sending the update is the same. The source addresses are the same. Therefore, the DNS server 102 accepts the update. The update is processed and the success of the update is returned to the client device 104.

In a second scenario, suppose that client device 105 sends a dynamic update for “lab-comp.corp.contoso.com” in an attempt to register its IP address. When the authoritative DNS server 102 is found, it checks for any existing A record for “lab-comp” in the “corp.contoso.com” zone. The A record for “lab-comp” already exists. Therefore, the DNS server checks to see if the source address of the original registrant and the source address of the client device sending the update is the same. The original registrant is client device 104, and client device 105 is sending the update, so their source IP addresses are not the same. DNS server 102 may reject the update. DNS server 102 may send a DNS query to client device 104. If an acknowledgement is received from client device 104 in response to the DNS query, then the DNS server 102 rejects the update. If no response to the DNS query is received from the client device 104, then the DNS server 102 may accept the update.

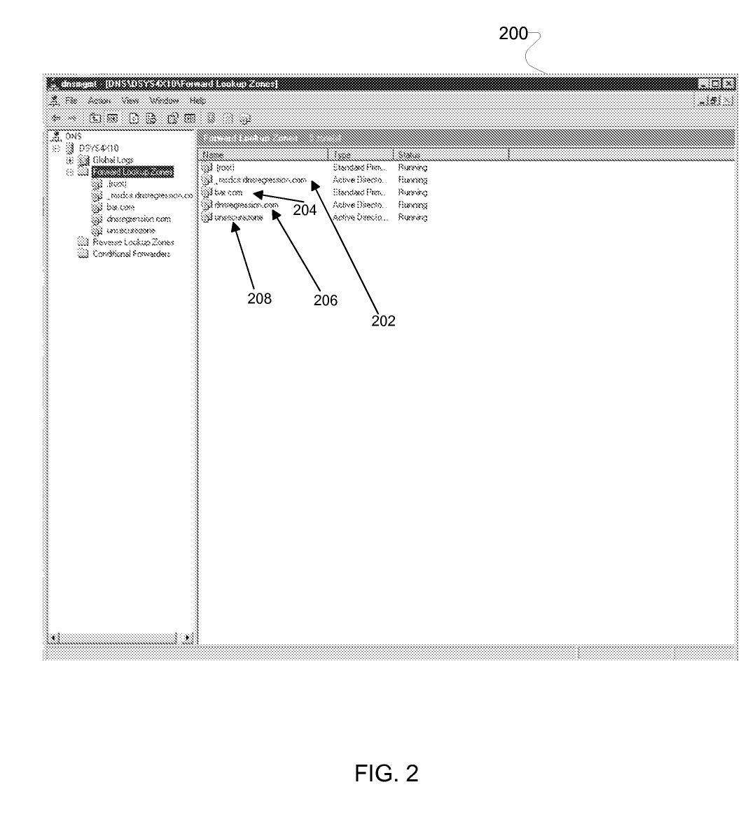

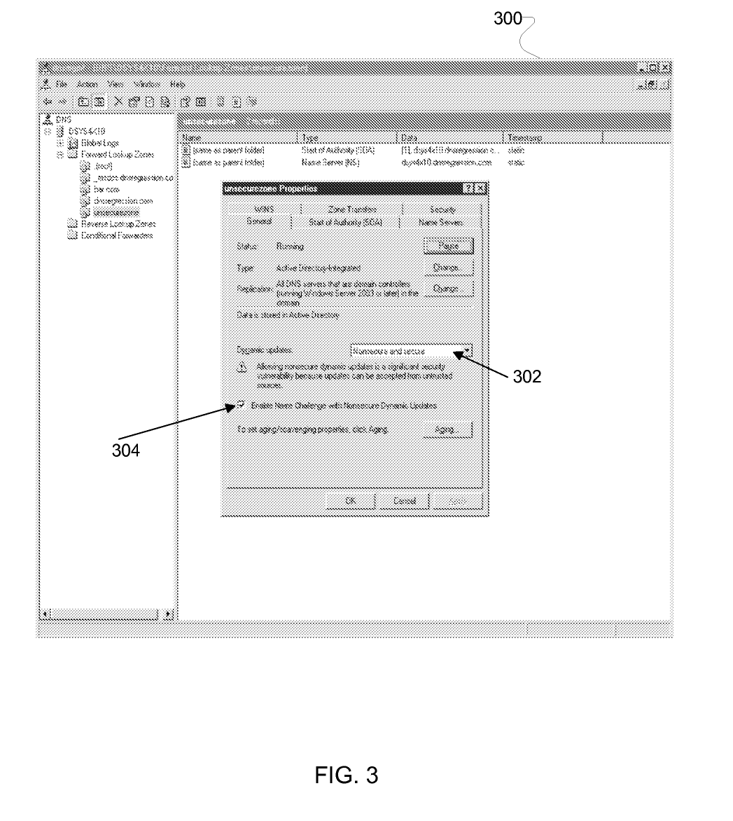

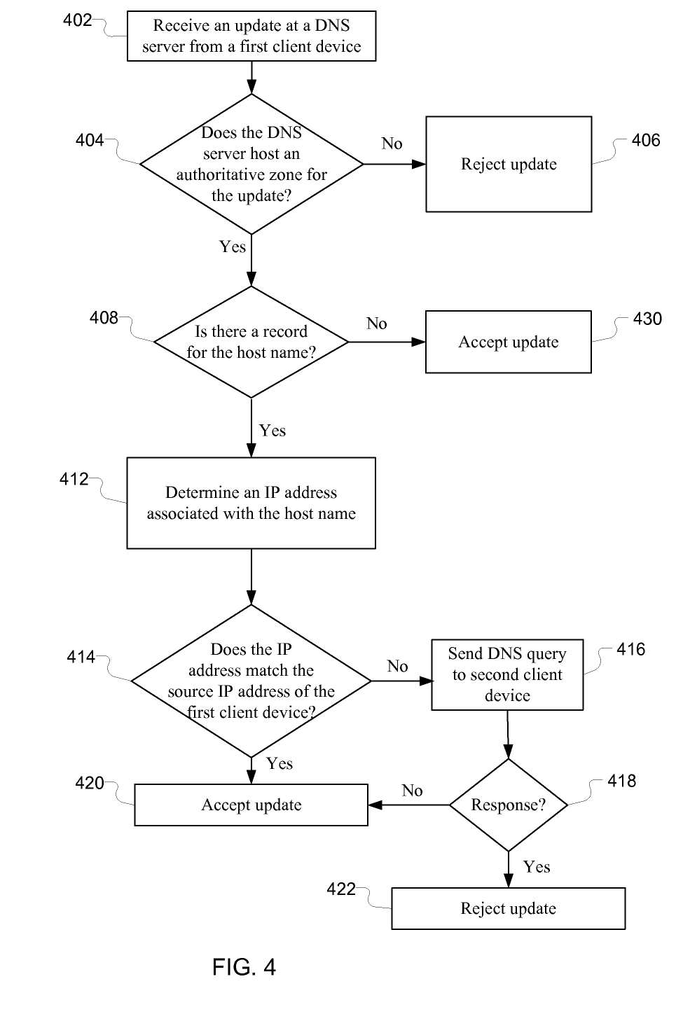

FIGS. 2-3 show screenshots 200 and 300 illustrating an exemplary user interfaces for managing DNS zones. In the system shown in FIG. 2, there are a plurality of DNS zones, including _msdcs.dnsregression.com 202, bar.com 204, dnsregression.com 206, and unsecure zone 208. A user may select a managed DNS zone and edit one or more properties of the selected zone. As shown in FIG. 3, the user has chosen to view and/or edit the properties of the unsecure zone 208. For each zone, the user may choose whether or not to enable dynamic updates for the zone. If the user chooses to enable dynamic updates, the user may choose to enable only secure updates or the user may choose to enable both secure and unsecure updates. In the example shown in FIG. 3, the user has chosen to enable both secure and unsecure updates, as shown at 302. When unsecure updates are enabled, the user may choose to enable name challenge for unsecure updates, as shown at 304. Once name challenge is enabled, the DNS server will challenge any updates for existing names as described in detail by the exemplary process of FIG. 4.

FIG. 4 is a flow diagram illustrating an exemplary process for name challenge enabled zones. While the description of FIG. 4 may be made with reference to other figures, it should be understood that the exemplary process illustrated in FIG. 4 is not intended to be limited to being associated with the systems or other contents of any specific figure or figures. Additionally, it should be understood that while the exemplary process of FIG. 4 indicates a particular order of operation execution, in one or more alternative implementations, the operations may be ordered differently. Furthermore, some of the steps and data illustrated in the exemplary process of FIG. 4 may not be necessary and may be omitted in some implementations. Finally, while the exemplary process of FIG. 4 contains multiple discrete steps, it should be recognized that in some environments some of these operations may be combined and executed at the same time.

At 402, an update for a name is received at a DNS server from a first client device. The update includes a host name. At 404, a determination is made as to whether the DNS server hosts an authoritative zone for the update. If so, then the process proceeds at 408. If not, then at 406, the update is rejected. When the DNS server that hosts the authoritative zone for the update is found, then at 408, the zone is checked to determine whether there is already a record for the host name. In determining whether there is already a record for the host name, one or more records of one or more record types may be checked. Example record types that may be checked include but are not limited to address (A) records, IPv6 address records, and Canonical Name (CNAME) records.

If no record for the host name is found, then at 430, the update is accepted. If there is already a record for the host name, then at 412, the source IP address associated with the host record is determined. At 414, the source IP address associated with the host record is compared to the source IP address of the first client device. If the IP addresses match, then at 420, the update is accepted. If the IP addresses do not match, then at 416, a DNS query is sent to a second client device having the IP address associated with the host record and at 418, a determination is made as to whether there is a response from the second client device. If an acknowledgement is received from the second client device in response to the DNS query, then at 422, the update is rejected. If no response to the DNS query is received from the second client device, then at 422, the update may be accepted. If the update is accepted and one or more other DNS servers have copies of the zone, then the update may be replicated to the one or more other DNS servers.

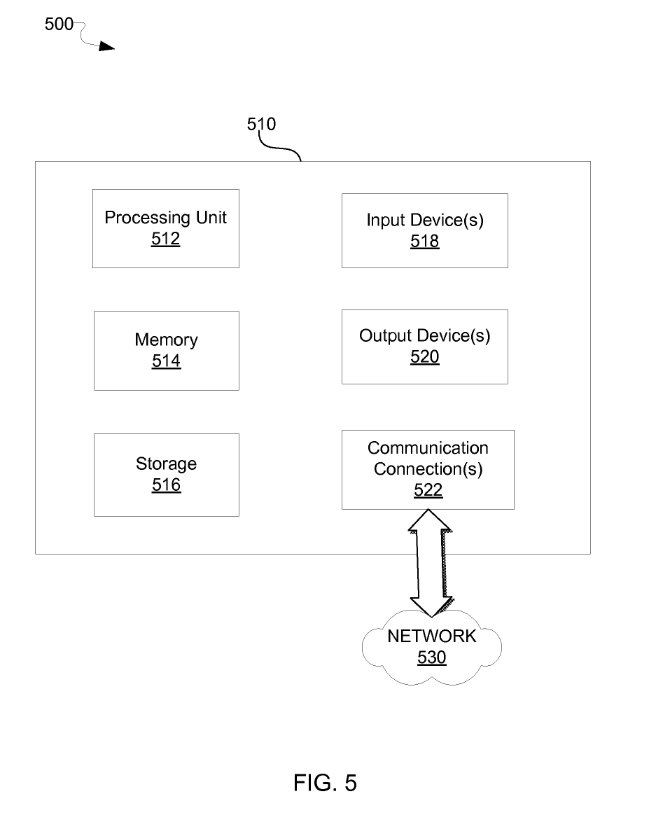

FIG. 5 illustrates an exemplary computing environment in which certain aspects of the invention may be implemented. It should be understood that computing environment 500 is only one example of a suitable computing environment in which the various technologies described herein may be employed and is not intended to suggest any limitation as to the scope of use or functionality of the technologies described herein. Neither should the computing environment 500 be interpreted as necessarily requiring all of the components illustrated therein.

The technologies described herein may be operational with numerous other general purpose or special purpose computing environments or configurations. Examples of well known computing environments and/or configurations that may be suitable for use with the technologies described herein include, but are not limited to, personal computers, server computers, hand-held or laptop devices, tablet devices, multiprocessor systems, microprocessor-based systems, set top boxes, programmable consumer electronics, network PCs, minicomputers, mainframe computers, distributed computing environments that include any of the above systems or devices, and the like.

With reference to FIG. 5, computing environment 500 includes a general purpose computing device 510. Components of computing device 510 may include, but are not limited to, a processing unit 512, a memory 514, a storage device 516, input device(s) 518, output device(s) 520, and communications connection(s) 522.

Processing unit 512 may include one or more general or special purpose processors, ASICs, or programmable logic chips. Depending on the configuration and type of computing device, memory 514 may be volatile (such as RAM), non-volatile (such as ROM, flash memory, etc.) or some combination of the two. Computing device 510 may also include additional storage (removable and/or non-removable) including, but not limited to, magnetic or optical disks or tape. Such additional storage is illustrated in FIG. 5 by storage 516. Computer storage media includes volatile and nonvolatile, removable and non-removable media implemented in any method or technology for storage of information such as computer readable instructions, data structures, program modules or other data. Memory 514 and storage 516 are examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 510. Any such computer storage media may be part of computing device 510.

Computing device 510 may also contain communication connection(s) 522 that allow the computing device 510 to communicate with other devices, such as with other computing devices through network 530. Communications connection(s) 522 is an example of communication media. Communication media typically embodies computer readable instructions, data structures, program modules or other data in a modulated data signal such as a carrier wave or other transport mechanism and includes any information delivery media. The term ‘modulated data signal’ means a signal that has one or more of its characteristics set or changed in such a manner as to encode information in the signal. By way of example, and not limitation, communication media includes wired media such as a wired network or direct-wired connection, and wireless media such as acoustic, radio frequency, infrared, and other wireless media. The term computer readable media as used herein includes storage media.

Computing device 510 may also have input device(s) 518 such as a keyboard, a mouse, a pen, a voice input device, a touch input device, and/or any other input device. Output device(s) 520 such as one or more displays, speakers, printers, and/or any other output device may also be included.

While the invention has been described in terms of several exemplary implementations, those of ordinary skill in the art will recognize that the invention is not limited to the implementations described, but can be practiced with modification and alteration within the spirit and scope of the appended claims. The description is thus to be regarded as illustrative instead of limiting.

1. A method comprising:
receiving an update at a domain name system (DNS) server from a first client device, the update including a host name;
determining whether the DNS server hosts an authoritative zone for the update;
determining whether there is already a record for the host name; and if so,
determining an Internet Protocol (IP) address associated with the host name;
determining whether the IP address associated with the host name matches a source IP address of the first client device; and
accepting the update if the IP addresses match.

2. The method of claim 1, further comprising accepting the update if there is no record for the host name.

3. The method of claim 1, further comprising sending a DNS query to a second client device having the IP address associated with the host name if the IP address associated with the host name does not match the source IP address of the first client device.

4. The method of claim 3, further comprising rejecting the update if an acknowledgement is received from the second client device in response to the DNS query.

5. The method of claim 3, further comprising accepting the update if no acknowledgement is received from the second client device in response to the DNS query.

6. The method of claim 1, further comprising replicating the update to another DNS server.

7. The method of claim 1, wherein determining whether there is already a record for the host name comprises checking multiple records of multiple types.

8. The method of claim 7, wherein one of the record types is an Address (A) record.

9. The method of claim 7, wherein one of the record types is an IPv6 address record.

10. The method of claim 7, wherein one of the record types is a Canonical Name (CNAME) record.

11. The method of claim 1, wherein the zone is file-backed.

12. The method of claim 1, wherein the zone is integrated with a directory system.

13. One or more device-readable media with device-executable instructions for performing steps comprising:
receiving an update from a first client device at a domain name system (DNS) server that hosts an authoritative zone for the update, the update including a host name;
checking one or more records in the zone to determine whether there is already a record for the host name, and if so,
checking the record for the host name to determine an Internet Protocol (IP) address associated with the host name;
determining whether the IP address associated with the host name matches a source IP address of the first client device, and if not,
sending a DNS query to a second client device having the IP address associated with the host name; and
determining whether to accept the update based on whether the second client device responds to the DNS query.

14. The one or more device-readable media of claim 13, wherein the steps further comprise accepting the update if there is no record for the host name.

15. The one or more device-readable media of claim 13, wherein the steps further comprise accepting the update if the IP address associated with the host name matches the source IP address of the first client device.

16. The one or more device-readable media of claim 13, wherein determining whether to accept the update based on whether the second client device responds to the DNS query comprises rejecting the update if the second client device responds to the DNS query and accepting the update if the second client device does not respond to the DNS query.

17. A method comprising:
receiving an update from a first client device at a domain name system (DNS) server, the update including a host name;
determining whether there is already a record for the host name; and if so,
determining a source IP address of a registrant of the host name;
determining whether the source IP address of the registrant of the host name matches the first client device's source IP address, and if not,
sending a DNS query to the registrant of the host name; and
rejecting the update if an acknowledgement is received from the registrant in response to the DNS query.

18. The method of claim 17, further comprising accepting the update if there is no record for the host name.

19. The method of claim 17, further comprising accepting the update if the source IP address of the registrant of the host name matches the first client device's source IP address.

20. The method of claim 17, further comprising accepting the update if no response is received from the registrant in response to the DNS query.
